(19) United States
(12) Patent Application Publication
(10) Pub. No.: US 2026/0073477 A1
(43) Pub. Date: Mar. 12, 2026

(54) IMAGE RECONSTRUCTION USING FREQUENCY DOMAIN PREDICTION FOR IMAGE PROCESSING SYSTEMS AND APPLICATIONS

(71) Applicant: NVIDIA Corporation, Santa Clara, CA (US)

(72) Inventors: Aviral AGRAWAL, Sunnyvale, CA (US); Ankitesh Kumar SINGH, Sunnyvale, CA (US); Manindra PARHY, Fremont, CA (US)

(21) Appl. No.: 18/830,219

(22) Filed: Sep. 10, 2024

(51) Int. Cl. G06T 5/10; G06T 3/4046; G06T 3/4053; G06T 3/4084; G06T 5/60

(52) U.S. Cl. CPC G06T 5/10; G06T 3/4046; G06T 3/4053; G06T 3/4084; G06T 5/60; G06T 2207/20064; G06T 2207/20081; G06T 2207/20084

(57) ABSTRACT

In various examples, wavelet prediction-based image reconstruction for image processing systems and applications is provided. A deep learning model may use derived frequency bands to predict sub-pixel-level information to perform predictive resampling as well as image/video artifact removal. The model may learn to predict missing frequency components while removing artifacts to generate resampled resolution image predictions based on the original input image. The model may comprise distinct frequency domain and spatial domain paths. The frequency domain path may process frequency domain sub-band images to introduce individualized non-linearity. Spatial domain prediction data may be generated based on the upsampled original input image. Substantive corrections may be applied by mapping the spatial domain prediction data into frequency sub-band images and the correcting sub-band images based on frequency domain prediction data. The resulting corrected sub-band images may be applied to an inverse DWT to reconstruct a resampled version.

### BACKGROUND

In systems that process and deliver video and image content, the resolution of image data is often adjusted from its original resolution to an alternate resolution. For example, the resolution of image data as presented on a display screen may be adjusted based on screen resolution. In some cases, the resolution of image data may be reduced to prepare the image data for transmission (e.g., over a network), followed by image resolution enhancement at the device receiving the transmitted image data. Each of the various types of upsampling, downsampling, compression, and other processing applied in the process of delivering content from a source to a destination may introduce artifacts (e.g., noise) that represent a degradation to the quality of the delivered image data as compared to the original image data. For example, downsampling of image data usually results in the loss of high-frequency details. When a downsampled image is upscaled back to a higher resolution, the inability to recover those high-frequency details may result in discontinuities, detail loss, and/or other visual artifacts.

### SUMMARY

Embodiments of the present disclosure relate to image reconstruction using wavelet frequency prediction.

In contrast to conventional systems, embodiments of this disclosure provide for a deep learning model that uses frequency bands (e.g., derived from an upsampled input signal), to predict sub-pixel-level information in order to perform predictive super-resolution upsampling as well as image/video artifact removal. The wavelet frequency model is able to perform (e.g., non-linear) adjustments to pixel values such that the adjustments are closer to the target resolution uncompressed quality rather than the present resolution of the original input image (with compressed or uncompressed quality) based at least on predicting sub-pixel information conditioned on the already present information in the content. As described herein, the wavelet frequency optimization model may learn to predict missing frequency components, which may be used to generate upsampled resolution image predictions based on the original input image, while removing artifacts from the frequency domain. The wavelet-based image reconstruction engine may use frequency sub-band processing (e.g., using a discrete wavelet transform (DWT)) to extract and apply adjustments to sub-pixel information within one or more of the extracted (e.g., transformed, decomposed, deconstructed, etc.) sub-bands. In some embodiments, the wavelet frequency optimization model may comprise a neural network architecture that includes distinct frequency domain and spatial domain paths, each comprising trainable sequences of two-dimensional convolution blocks, residual blocks, and/or activation function blocks (where a block defines a set of one or more neural network layers that propagate a defined function). The frequency domain path of the wavelet frequency optimization model may input and process the one or more of the frequency sub-band images (e.g., low-low (LL), low-high (LH), high-low (HL), and high-high (HH) sub-band images) produced by the DWT from the upsampled original input image—to introduce individualized non-linearity to those frequency sub-bands. Spatial domain prediction data may be generated based on the upsampled original input image, which retains the image characteristics of the original input image, but may include artifacts not present in the original input image. Substantive corrections to address artifacts may be applied by mapping the spatial domain prediction data into frequency sub-band images and correcting one or more of those sub-band images based on the prediction data generated by the frequency domain path of the wavelet frequency optimization model. The resulting set of corrected LL, LH, HL, and HH sub-band images may then be applied to an inverse DWT to reconstruct a resampled version (e.g., a wavelet-based reconstruction) of the original input image that is adjusted to mitigate artifacts.

### BRIEF DESCRIPTION OF THE DRAWINGS

The present systems and methods for wavelet prediction-based image reconstruction for image processing systems and applications are described in detail below with reference to the attached drawing figures, wherein:

FIG. 1 is a data flow diagram for an example image processing system that comprises a wavelet-based image reconstruction engine, in accordance with some embodiments of the present disclosure;

FIG. 2 is a data flow diagram for an example wavelet-based image reconstruction engine comprising a wavelet frequency optimization model, in accordance with some embodiments of the present disclosure;

FIG. 3 is a diagram illustrating example neural network block functions, in accordance with some embodiments of the present disclosure;

FIG. 4 is a diagram illustrating an example training architecture for training a wavelet frequency optimization model, in accordance with some embodiments of the present disclosure;

FIG. 5 is a flow diagram showing an example method for wavelet-based image reconstruction, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to wavelet prediction-based image reconstruction for image processing systems and applications.

Some existing approaches for artifact reduction in image and video image data attempt to utilize sub-pixel information guided by the values of neighboring pixels by performing linear operations, such as regression. However, such methods are not sufficient for reconstructing high-frequency information because they have no capacity to recover information that cannot be regressed from the neighboring pixels. Neural network-based approaches (using Residual Neural Network (ResNet)-based frameworks, for example) have been proposed that combine spatial domain (e.g., normal image space) processing with residual layers that allow for non-linear optimizations. However, the inclusion of residual blocks still does not allow for the recovery of lost high-frequency information that is absent from a downsampled image input. Other solutions propose the use of a Discrete Wavelet Transform (DWT) in order to enhance the learning power of an image denoising model by creating neural network architectures specifically designed for learning relationships between features in a DWT domain (e.g., based on using wavelet transform processing embedded into the architecture and/or using an attention module to receive inputs from wavelet transform-based signals). For example, such an image denoising model may extract convolutional neural network (CNN)-based features, and then process those in the DWT domain, and then output features that may be used to reconstruct information in the spatial domain. However, such models may not provide feasible solutions for a wide variety of use cases. The use of an attention module substantially adds to the complexity and inference time of such solutions, rendering them impractical when facilitating quicker inference and wide-scale deployment are considerations.

In contrast to these prior solutions, embodiments of this disclosure provide for a wavelet frequency optimization-based deep learning model that uses frequency bands (e.g., derived from an upsampled input signal) to predict sub-pixel-level information in order to perform predictive super-resolution upsampling as well as image/video artifact removal. Training of the model may be based on a training framework that breaks down learning for non-linear optimizations into focused high-frequency, low-frequency, and general spatial domain learning. Based on the training, the wavelet frequency model is able to perform (e.g., non-linear) adjustments to pixel values such that the adjustments are coherent with (closer to) the target resolution uncompressed quality rather than the present resolution quality of the original input image (with compressed or uncompressed quality) based at least on predicting sub-pixel information conditioned on the already present information in the content. As described herein, the wavelet frequency optimization model may learn to predict missing frequency components while removing artifacts from the frequency domain, which may be used to generate upsampled resolution image predictions based on the original input image. In some embodiments, the wavelet frequency optimization model may learn to generate pixel values based not only on a target resolution but also of a lossless quality, as an input image may be of lower resolution and compressed (e.g., to a lossy quality).

In some embodiments, an image processing system may comprise a wavelet-based image reconstruction engine that includes a wavelet frequency optimization model, as described herein. The wavelet-based image reconstruction engine may use frequency sub-band processing (e.g., using a discrete wavelet transform (DWT)) to extract and apply (e.g., non-linear) adjustments to sub-pixel information within one or more of the derived sub-bands. More specifically, the wavelet frequency optimization model may be trained to predict high-frequency sub-band information, which is typically the type of information that may be determined using attention techniques. The wavelet frequency optimization model may be trained to predict low-frequency sub-band information, which primarily represents spatial data, and may facilitate correction of domain shift, mean shift, and/or similar issues that can affect image reconstruction. The wavelet frequency optimization model may further be trained to predict spatial domain reconstructions. Training may comprise combining multiple losses distributed across the various paths of the model, as further described herein.

With respect to frequency sub-band derivation, DWT may be performed at one or more stages of the wavelet-based image reconstruction engine. A DWT algorithm may represent (e.g., derive, decompose, deconstruct, etc.) an input image into four sub-band images, referred to as the low-low (LL) sub-band, the high-low (HL) sub-band, the low-high (LH) sub-band, and the high-high (HH) sub-band. The four sub-band images, when arranged into quadrants of a square, may produce a DWT representation image having the same dimensions (e.g., in terms of horizontal and vertical pixels) as the original image. The LL sub-band is the sub-band that includes the lowest frequency components of the input image, and the LL sub-band image may represent and visually appear as a natural looking spatial approximation of the original input image. As discussed herein, an LL sub-band image may also serve as the input image for performing further DWT operations (e.g., to obtain a multi-level deconstruction/decomposition). The HH sub-band is the sub-band that includes the highest frequency components of the input image, and is the sub-band most prone to data loss (e.g., due to downsampling and/or compression) and corruption from high-frequency noise introduced from image processing. The HH sub-band image may represent and visually appear as comprising a rendering of diagonal features from the input image. The LH and HL sub-bands comprise mid-frequency bands between the LL and HH sub-bands. The LH sub-band image may represent and visually appear as extractions of horizontal features from the input image. The HL sub-band image may represent and visually appear as extractions of vertical features from the input image. Because the DWT algorithm is an invertible algorithm, given the derived LL, LH, HL, and HH sub-band images as inputs, the original image may be recovered using an Inverse DWT (IDWT) algorithm.

The wavelet-based image reconstruction engine may receive an image data input (e.g., an image frame and/or frames of video) and perform an upsampling to resample the input image to higher resolution image data. The resolution of the upsampled original image data may define the target resolution for the upsampled resolution image prediction output generated by the wavelet image reconstruction engine. In some embodiments, the upsampling may comprise a bicubic resampling based on bicubic interpolation techniques. Bicubic resampling may generate new pixels based on the local intensity of neighboring pixels to attempt to preserve structure such as (without limitation) edges and textures. However, as discussed above, such resampling techniques have no capacity to recover high-frequency information that cannot be regressed from the neighboring pixels and therefore may produce upsampled original image data that is at least partially corrupted by artifacts. The wavelet-based image reconstruction engine may then generate derived frequency sub-band images (e.g., LL, LH, HL, and HH sub-band images) of the upsampled original input image data by applying the upsampled original input image data to a DWT algorithm. The wavelet frequency optimization model may then use the upsampled original input image data and frequency sub-band images as inputs to generate one or both of frequency prediction data and/or spatial domain prediction data. A wavelet-based reconstruction may then be performed based on these predictions from the wavelet frequency optimization model (as further detailed below) to produce an upsampled resolution image prediction output from the wavelet image reconstruction engine.

In some embodiments, the wavelet frequency optimization model may comprise a neural network architecture that includes distinct frequency domain and spatial domain paths, each comprising trainable sequences of two-dimensional convolution blocks, residual blocks, and/or activation function blocks (where a block defines a set of one or more neural network layers that propagate a defined function). For example, a convolution block may comprise a set of learnable filters (e.g., kernels), that are convolved with two-dimensional (2D) input data to perform an elementwise multiplication and summation to compute values for each pixel. A convolutional layer may output a feature map that represents certain features extracted from the input of the convolution block. An activation function block may introduce non-linearities to model complex relationships in the input data. Example activation functions include, but are not limited to, the Rectified Linear Unit (ReLU) activation function and the sigmoid activation function. Residual blocks are used so that deeper layers of a neural network may learn directly from shallower layers, facilitating network convergence for improved learning and imagined recognition tasks. Residual blocks may be formed using one or more skip connections that connect layers to subsequent layers by skipping one or more layers in between—such that layers of residual blocks may be trained, based on learning the residual (delta) between a target ground truth value and an input from a skip connection.

The frequency domain path of the wavelet frequency optimization model may input and process the one or more of the frequency sub-band images (e.g., LL, LH, HL, and HH sub-band images) produced by the DWT from the upsampled original input image—to introduce individualized non-linearity to those (derived) frequency sub-bands. In some embodiments, the frequency domain path may include, for each individual frequency sub-band, a residual block-based framework comprising a sequence of one or more convolution and activation function blocks to generate sub-band image prediction for that sub-band. Based on the training process used to develop the wavelet frequency optimization model, the residual block-based frameworks for the individual sub-bands learn to apply corrections (e.g., non-linear adjustments) to the sub-band images to incorporate frequency data that the model has learned to infer should be present in each respective derived frequency sub-band.

In some embodiments, the frequency domain path of the wavelet frequency optimization model may input and process fewer than all of the sub-band images (e.g., in order to reduce the complexity and/or resources for implementing the wavelet frequency optimization model). For example, as discussed herein, the HH sub-band is the sub-band most prone to high-frequency data loss and/or corruption, while the low-frequency data of the LL sub-band image captures spatial information. As such, in some embodiments, the frequency domain path may include a framework to produce an LL sub-band image prediction component of the frequency prediction data, and an HH sub-band image prediction component of the frequency prediction data. As described below, the frequency prediction data (e.g., the sub-band image predictions) generated by the frequency domain path of the wavelet frequency optimization model may be used in conjunction with spatial domain prediction data generated by the spatial domain path of the wavelet frequency optimization model to perform a wavelet-based reconstruction that generates the upsampled resolution image prediction output.

With respect to the spatial domain path of the wavelet frequency optimization model, the spatial domain path inputs and processes the upsampled original input image to introduce non-linear corrections in the spatial domain of the upsampled image. In some embodiments, the spatial domain path may include a residual block-based framework comprising a sequence of one or more convolution and activation function blocks to generate the spatial domain prediction data. Based on the training process used to develop the wavelet frequency optimization model, the residual block-based frameworks for the spatial domain path may learn to apply corrections (e.g., non-linear adjustments) to the upsampled original input image to incorporate spatial data that the model has learned to infer should be present. That is, the spatial domain path applies corrections across the spatial domain based on parameter sharing, where convolution blocks convolve across pixel data without regard to frequency sub-bands. With parameter sharing, parameters (e.g., weights) may be shared across neurons producing a particular feature map. That is, a convolutional layer may use shared neuron weights to produce a feature map that represents certain features extracted throughout the image - thus reducing the number of weights to be learned during training.

Spatial domain prediction data may be generated based on the upsampled original input image, which retains the image characteristics of the original input image, but may include artifacts not present in the original input image. As such, the spatial domain path residual computations may be subtle, so as to avoid changing the basic characteristics of the image as represented in the spatial domain prediction data. Substantive corrections to address visible artifacts may instead be applied by mapping the spatial domain prediction data into derived frequency sub-band images (e.g., LL, LH, HL, and HH sub-band images produced by a DWT algorithm) and correcting one or more of those sub-band images based on the frequency prediction data (e.g., the LL, LH, HL, and/or HH sub-band image predictions) generated by the frequency domain path of the wavelet frequency optimization model. In some embodiments, such corrections may be applied by replacing one or more of the sub-band images from the spatial domain prediction data with the corresponding sub-band images from the frequency prediction data. For example, the HH sub-band image derived from the spatial domain prediction data may be replaced with the HH sub-band image prediction generated by the frequency domain path, and the LL sub-band image derived from the spatial domain prediction data may be replaced with the LL sub-band image prediction generated by the frequency domain path. Because the frequency domain path has specifically learned how to predict what HH and/or LL sub-band images should look like without artifacts, using those derived sub-band predictions in place of the HH and/or LL sub-band images derived from the spatial domain prediction data will introduce sharpness in high-frequency details without injecting artifacts. The resulting set of corrected LL, LH, HL, and HH sub-band images may then be applied to an inverse DWT to reconstruct a super-resolution version (e.g., a wavelet-based reconstruction) of the original (lower resolution) input image that is adjusted to mitigate artifacts.

In some embodiments, a wavelet frequency optimization model may generate sub-band predictions for each of the frequency sub-band images (e.g., LL, LH, HL, and HH sub-band image predictions). In some such embodiments, the predicted set of LL, LH, HL, and HH sub-band image predictions may be applied to an inverse DWT to reconstruct a super-resolution version, rather than (or in addition to) being used to correct LL, LH, HL, and HH sub-band images derived from spatial domain prediction data. Such embodiments may be attractive in uses cases where ample processing resources are available to generate the complete set of sub-band predictions within time limits applicable for those use cases.

The wavelet frequency optimization model may comprise a deep neural network (DNN) architecture, such as a convolutional neural network (CNN), recurrent neural network (RNN), or other DNN-based model. As discussed herein, the wavelet frequency optimization model may comprise distinct frequency domain and spatial domain paths comprising residual block-based frameworks that are trained using a loss function designed to optimize various multiple loss components distributed across the paths. During training, the wavelet frequency optimization model may be iteratively trained (e.g., thousands of iterations) using training data samples, while blocks of the model are adjusted over the iterations to drive a feedback loss towards a minimum. For example, a training data sample may comprise a ground truth image (e.g., a canonical image that has not been previously downsampled) and a training image comprising a downsampled version of the ground truth image. In some embodiments, the training process for the wavelet frequency optimization model is based on an end-to-end training using the wavelet-based image reconstruction engine. For example, the training image (e.g., the downsampled version of the ground truth image) may be provided as an original input to the wavelet-based image reconstruction engine, which may upsample the training image and process the upsampled training image into the one or more derived frequency sub-band images (e.g., using a DWT algorithm). The wavelet frequency optimization model may then use the upsampled training image and derived frequency sub-band images as inputs to generate frequency domain prediction data (e.g., LL, LH, HL, and HH sub-band image predictions) and spatial domain prediction data.

The wavelet-based image reconstruction engine processes the spatial domain prediction data into frequency sub-band images (e.g., LL, LH, HL, and HH sub-band images) and applies corrections to the frequency sub-band images by replacing one or more of the sub-band images with a corresponding sub-band image prediction (e.g., an LL, LH, HL, and/or HH sub-band image prediction). Wavelet-based reconstruction may be performed by applying the set of corrected sub-band images to an inverse DWT to reconstruct a resampled (e.g., super-resolution) version of the original training image, which is provided as output from the wavelet-based image reconstruction engine as an upsampled resolution image prediction. To compute the feedback loss, the training process may further include generating one or more frequency sub-band images (e.g., using a DWT algorithm) from the ground truth image to produce one or more LL, LH, HL, and/or HH sub-band ground truth images. To generate the feedback loss, a loss function may compute a respective loss component associated with each sub-band image prediction based on its corresponding sub-band ground truth image. For example, the loss function may input the HH sub-band image prediction produced by the model and the HH sub-band ground truth image, and compute an L1 loss (e.g., a mean absolute error loss) between the images. Similarly, the loss function may input the LL sub-band image prediction produced by the model and the LL sub-band ground truth image, and compute an L1 loss between those images. In some embodiments, an L1 loss may similarly be computed by the loss function for the HL and LH sub-bands. Each of the L1 losses associated with the sub-band image prediction defines components of the feedback loss used for iteratively adjusting the wavelet frequency optimization model to drive those L1 losses toward zero. With respect to end-to-end training, the feedback loss further comprises at least one loss computed by the loss function based on comparing the upsampled resolution image prediction output from the wavelet-based image reconstruction engine to the training data sample ground truth image. Based on detecting deviations between the upsampled resolution image prediction and the training data sample ground truth image, the loss function may compute an L1 loss and/or an L2 loss (e.g., a mean-squared error loss) that is fed back as a component of the feedback loss and used for iteratively adjusting the wavelet frequency optimization model to drive those L1 and/or L2 losses toward zero. As should be appreciated, an L1 loss is outlier sensitive and therefore may be used to prevent the model from training on spurious frequency data, whereas the L2 loss is less outlier sensitive but may assist a model in learning to produce image predictions of better visual quality. It should be understood that L1 and L2 losses are discussed here for example purposes and that other embodiments may use loss functions that compute different losses for optimizing sub-band image predictions and/or upsampled resolution image predictions. In some embodiments, the loss components for different sub-band image predictions may be weighted differently with respect to each other using scaling factors to emphasis training for one sub-band over another. For example, the HH sub-band loss component may be scaled based on a first scaling factor while the LL sub-band loss component may be scaled based on a second (smaller) scaling factor to focus learning on driving the HH sub-band loss to a minimum over driving the LL sub-band loss to a minimum.

It should also be understood that in some embodiments, frequency sub-band image predictions may be computed based on multi-level DWT operations—using an LL sub-band image prediction from a first iteration to compute a second set of frequency sub-band image predictions—where the wavelet frequency optimization model may be trained in the same manner described herein to optimize losses associated with the higher level frequency sub-band image predictions.

In some embodiments, one or more functions or components of the wavelet-based image reconstruction engine and/or wavelet frequency optimization model described herein may be executed using computing platforms comprising processing units such as, but not limited to, one or more central processing units (CPUs), graphic processing units (GPUs), neural processing units (NPU) and/or one or more deep learning accelerators (DLAs).

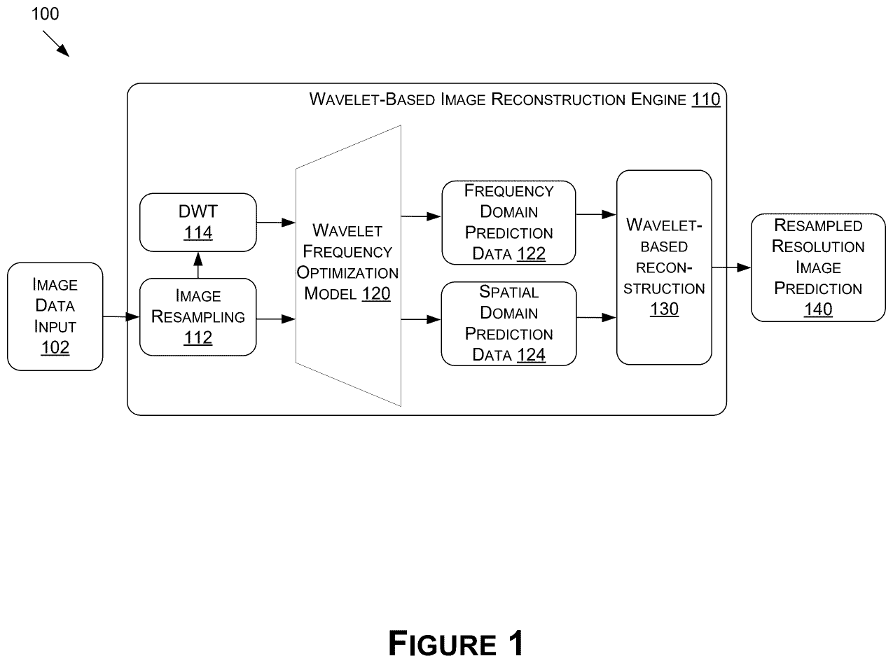

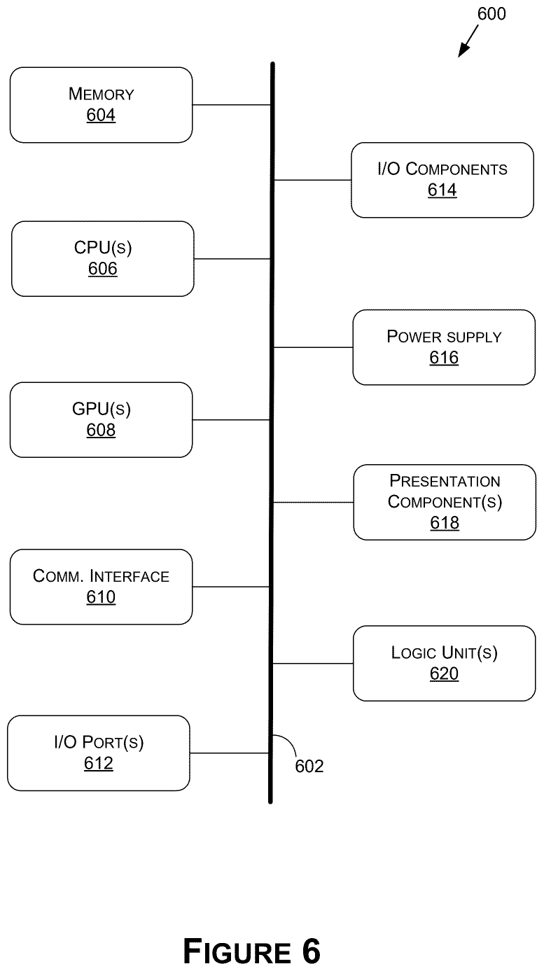

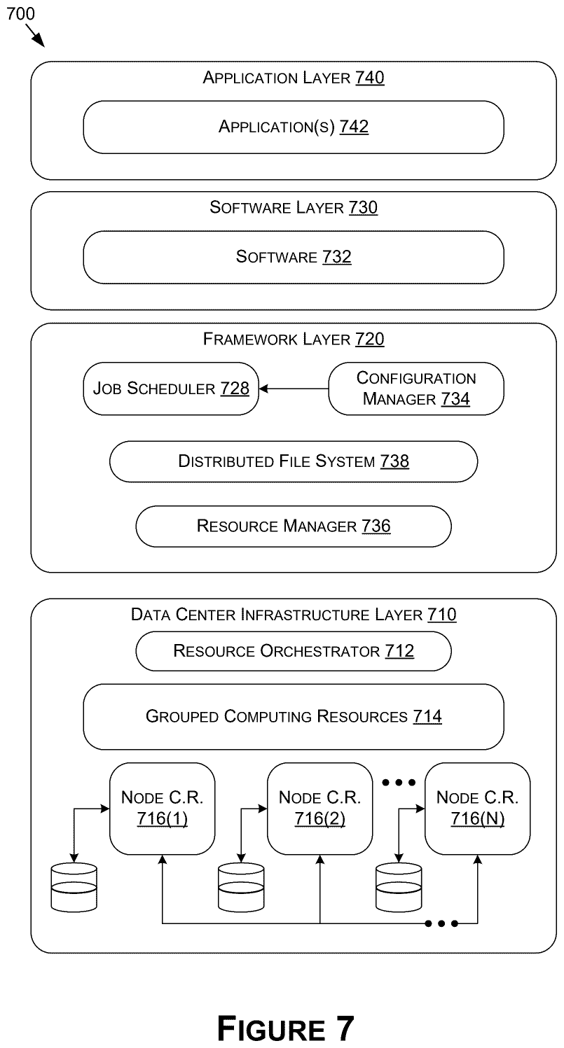

With reference to FIG. 1, FIG. 1 is an example data flow diagram of a process for an image processing system 100 that comprises a wavelet-based image reconstruction engine 110, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example computing device 600 of FIG. 6, and/or example data center 700 of FIG. 7.

As shown in FIG. 1, an image processing system 100 may comprise a wavelet-based image reconstruction engine 110 that can generate a resampled resolution image in the form of a resampled resolution image prediction 140 based on an image data input 102. In various embodiments, the resampling performed by the wavelet-based image reconstruction engine 110 may comprise an upsampling reconstruction (e.g., producing a higher resolution image of an image represented by the image data input 102), a downsampling reconstruction (e.g., producing a lower resolution image of an image represented by the image data input 102), or a fixed resolution reconstruction (e.g., producing an image having the same resolution as an image represented by the image data input 102, which may be performed for denoising purposes). The image data input 102 may comprise one or more image frames comprising image content or video (e.g., sequential image) content. In some embodiments, the image data input 102 may represent images that were cropped from larger images, downsampled, filtered, or otherwise processed from an original image using one or more lossy algorithms (e.g., algorithms and/or codecs that discard information from the original image data considered less important or undetectable to the human eye). The resulting image data input 102 may therefore comprise one or more artifacts—small distortions in an image or video caused by the lossy algorithms. While such artifacts may sometimes be visually de minimis when rendering a frame of the image data input 102 at its current resolution, those artifacts may become amplified or cause further distortions when the image data input 102 is resampled, for example upsampled for display on a device providing higher resolution than the resolution of the image data input 102. In some embodiments, the image data input 102 may comprise one or more image frames as captured by one or more optical image sensors. In some embodiments, the image data input 102 may be captured by an optical image sensor comprising a camera, such as a red, green, and blue (RGB), infrared (IR), and/or RGB-IR camera. In some embodiments, image data input 102 may comprise simultaneously captured image frames from multiple optical image sensors that are stitched together to form a composite image frame for input to the wavelet-based image reconstruction engine 110.

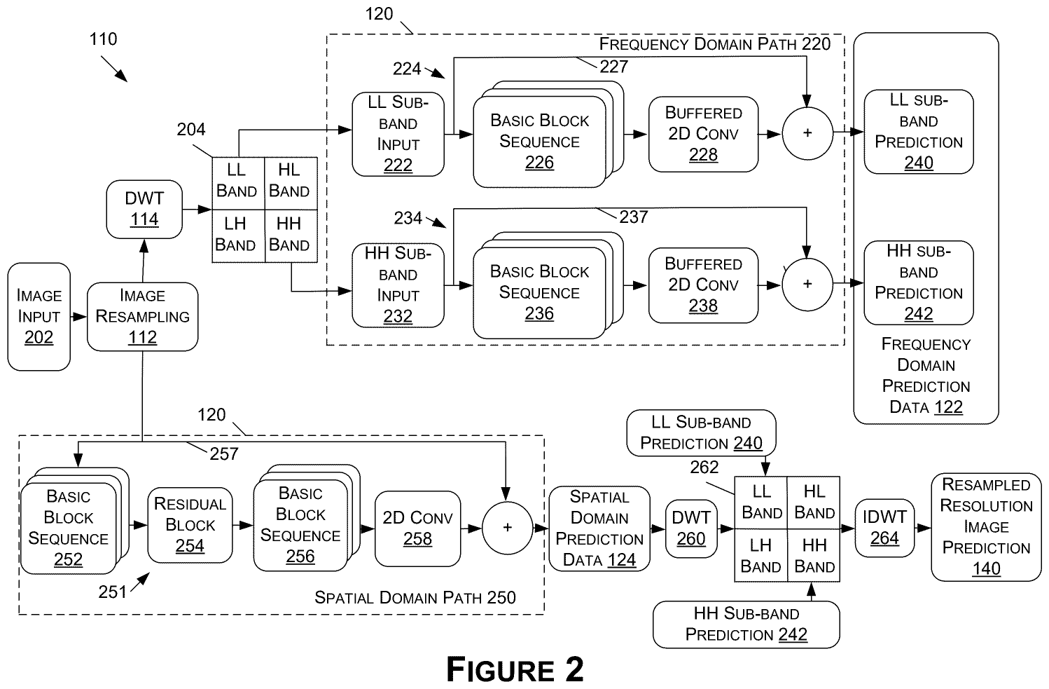

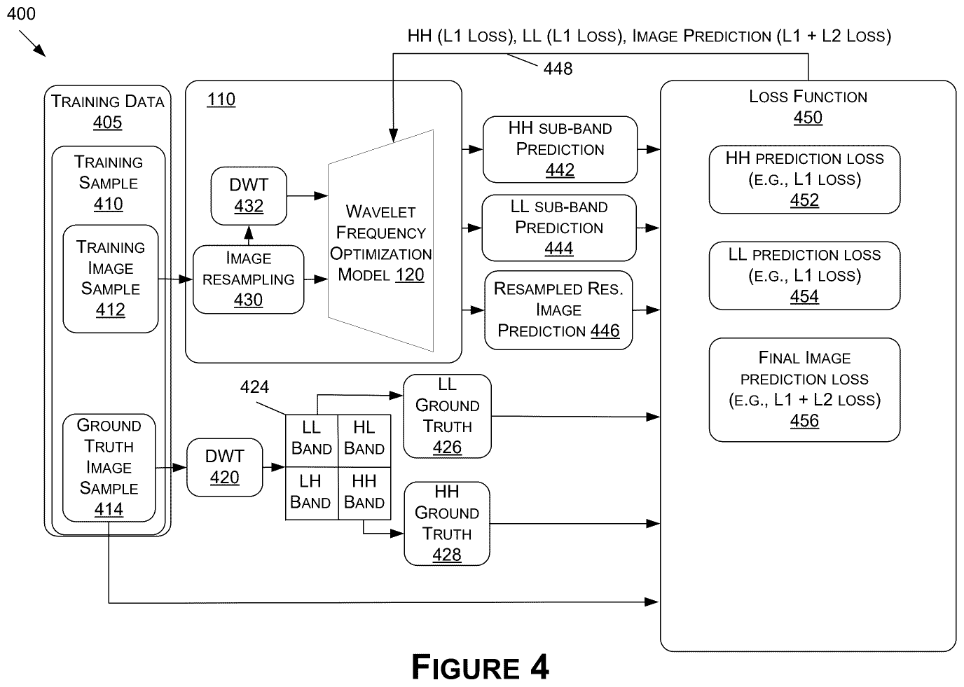

As shown in FIG. 1 and discussed herein, the wavelet-based image reconstruction engine 110 may comprise a wavelet frequency optimization model 120. The wavelet frequency optimization model 120 comprises a neural network architecture, which may be implemented, for example, using one or more of a Convolutional Neural Network (CNN), Deep Neural Network (DNN), recurrent neural network (RNN), and/or other DNN-based model or machine learning model architecture(s). In some embodiments, the wavelet-based image reconstruction engine 110 and/or wavelet frequency optimization model 120 may comprise a neural network architecture such as described herein with respect to FIG. 2, and which may be trained using a training architecture as described herein with respect to FIG. 4.

The wavelet frequency optimization model 120 uses frequency bands derived from a resampling of the image data input 102 to predict sub-pixel-level information in order to perform, for example, predictive upsampling or downsampling, as well as image/video artifact removal. As illustrated in FIG. 1, the wavelet-based image reconstruction engine 110 may perform an image resampling 112, for example, to upsample the input image to higher resolution image data. The resolution of the resampled original image data may define the target resolution for the resampled resolution image prediction 140 output generated by the wavelet image reconstruction engine 110. In some embodiments, image resampling 112 may comprise a bicubic resampling based on bicubic interpolation techniques. The wavelet-based image reconstruction engine may process the resampled original image data frequency sub-band decomposition, such as a DWT 114, to generate frequency sub-band images (e.g., LL, LH, HL, and HH sub-band images) of the upsampled original input image data. The wavelet frequency optimization model 120 may then input the upsampled original input image data and frequency sub-band images to generate one or both of frequency domain prediction data 122 and/or spatial domain prediction data 124. The wavelet image reconstruction engine 110 may perform a wavelet-based reconstruction 130 based on predictions from the wavelet frequency optimization model 120 to produce a resampled (e.g., upsampled) resolution image prediction output from the wavelet image reconstruction engine 110.

An example process performed by the wavelet-based image reconstruction engine 110 may be considered in greater detail, as described with respect to FIG. 2. As shown in FIG. 2, the wavelet frequency optimization model 120 may comprise a neural network architecture that includes a frequency domain path 220 and a spatial domain path 250. Each path may comprise trainable sequences of two-dimensional (2D) convolution blocks, residual blocks, activation function blocks, or other functional blocks (where a block defines a set of one or more neural network layers that propagate a defined function).

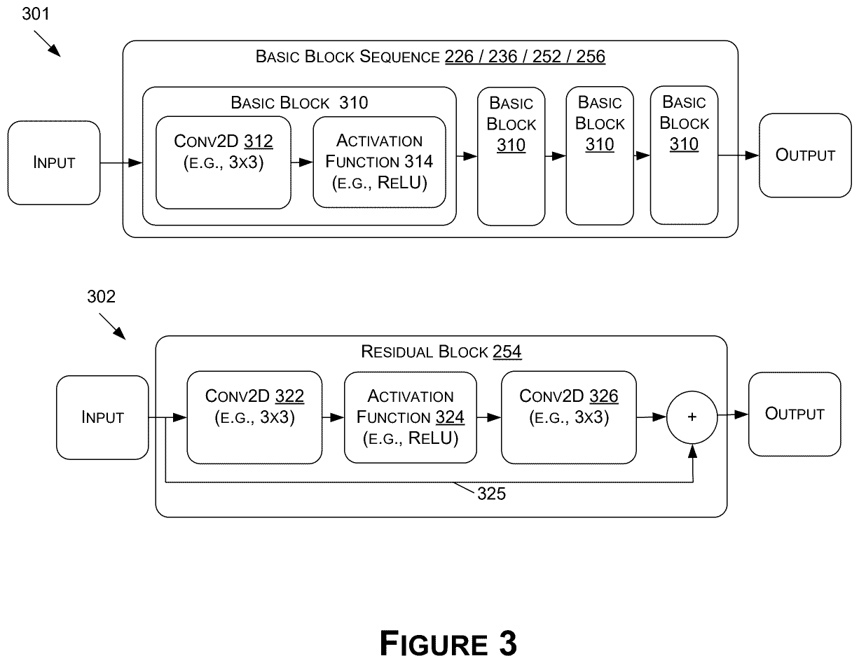

The frequency domain path 220 may input and process the one or more frequency sub-band images 204 (e.g., LL, LH, HL, and HH sub-band images) produced by the DWT 114 based on the upsampled original input image. The frequency domain path 220 may include, for respective individual frequency sub-bands of the frequency sub-band images 204, a framework comprising a sequence of one or more convolution and activation function blocks, to generate a sub-band image prediction for that sub-band. In some embodiments, the frequency sub-band images 204 may be individually processed using a respective residual block-based framework. In the example wavelet frequency optimization model 120 shown in FIG. 2, the frequency domain path 220 comprises a first residual block framework 224 that is trained to generate an LL sub-band prediction 240 based on an LL sub-band input 222 obtained from the frequency sub-band images 204. The first residual block framework 224 may comprise, for example, a basic block sequence 226 (e.g., a sequentially connected set of one or more neural network basic blocks, such as basic block 310 shown in FIG. 3), a buffered 2D convolution block 228 (e.g., a 3×3 2D convolution block with padding to provide a spatial resolution output that is the same as LL sub-band input 222), and a skip connection 227 that feeds forward LL sub-band input 222. During training of this first residual block framework 224, the weights of neural network connections of the basic block sequence 226 and/or the buffered 2D convolution block 228 are iteratively adjusted to learn non-linear corrections to apply to the LL sub-band input 222 that minimize differences between the LL sub-band prediction 240 and a ground truth LL sub-band image. In this way, the frequency domain path 220 learns to apply non-linear corrections to the LL sub-band image 222 to incorporate frequency data that the model has learned to infer should be present in the frequency LL sub-band.

In this example, the frequency domain path 220 further comprises a second residual block framework 234 that is trained to generate an HH sub-band prediction 242 based on an HH sub-band input 232 obtained from the frequency sub-band images 204. The second residual block framework 234 may comprise, for example, a basic block sequence 236 (e.g., a sequentially connected set of one or more neural network basic blocks, such as basic block 310 shown in FIG. 3), a buffered 2D convolution block 238 (e.g., a 3×3 2D convolution block with padding to provide a spatial resolution output the same as HH sub-band input 232), and a skip connection 237 that feeds forward HH sub-band input 232. During training of this second residual block framework 234, the weights of neural network connections of the basic block sequence 236 and/or the buffered 2D convolution block 238 are iteratively adjusted to learn non-linear corrections to apply to the HH sub-band input 232 that minimize differences between the HH sub-band prediction 242 and a ground truth HH sub-band image. In this way, the frequency domain path 220 learns to apply non-linear corrections to the HH sub-band image 232 to incorporate frequency data that the model has learned to infer should be present in the derived frequency HH sub-band. The LL sub-band prediction 240 and HH sub-band prediction 242 define the set of frequency domain prediction data 122. In some embodiments, such as shown in FIG. 2, the frequency domain path 220 may input and process fewer than all derived frequency sub-band images 204. This may be done for efficiency, for example in order to reduce the complexity and/or resources for implementing the wavelet frequency optimization model 120. Here, the HH sub-band may be selected because it is the sub-band most prone to high-frequency data loss and/or corruption, while the LL sub-band is selected because the low-frequency data of the LL sub-band image captures spatial information. However, as discussed herein, in some embodiments the frequency domain path 220 may comprise respective residual block frameworks trained to compute corrections and predictions for each of the LL, LH, HL, and HH sub-band images, or any combination thereof.

The spatial domain path 250 inputs and processes the resampled original input image produced by image resampling 112 to introduce non-linear corrections in the spatial domain of the upsampled image to produce the spatial domain prediction data 124. The spatial domain path 250 may comprise a residual block framework 251 that is trained to generate the spatial domain prediction data 124 based on the resampled original input image. The residual block framework 251 may comprise, for example, a first basic block sequence 252 (e.g., a sequentially connected set of one or more neural network basic blocks, such as basic block 310 shown in FIG. 3), a residual block 254 (such as shown in FIG. 3), a second basic block sequence 256 (e.g., such as shown in FIG. 3), and/or a buffered 2D convolution block 258 (e.g., a 3×3 2D convolution block with padding to provide a spatial resolution output the same as the resampled original input image produced by image resampling 112), and a skip connection 257 that feeds forward the resampled original input image produced by image resampling 112. During training of this residual block framework 251, the weights of neural network connections of the basic block sequences 226 and 256, residual block 254, and/or the buffered 2D convolution block 258 are iteratively adjusted to learn non-linear corrections to apply to the resampled original input image that minimize differences between the resampled resolution image prediction 140 and the training data sample ground truth image. Based on the training process used to develop the wavelet frequency optimization model, the framework for the spatial domain path 250 may learn to apply corrections (e.g., non-linear adjustments) to the resampled original input image to incorporate spatial data that the model has learned to infer should be present. Spatial domain prediction data 124 may comprise a resampled version of the original input image 202 that retains the image characteristics of the original input image 202, but may include artifacts not present in the original input image 202. As such, the residual computations applied by the spatial domain path 250 may be subtle, so as to avoid changing the basic characteristics of the image as represented in the spatial domain prediction data 124. Substantive corrections to address artifacts in the spatial domain prediction data 124 may instead be applied by mapping the spatial domain prediction data 124 into frequency sub-band images 262 (e.g., LL, LH, HL, and HH sub-band images produced by a DWT algorithm 260) and correcting one or more of those sub-band images based on the sub-band predictions from frequency domain prediction data 122.

Based on the frequency domain prediction data 122 and spatial domain prediction data 124, the wavelet image reconstruction engine 110 may perform a wavelet-based reconstruction 130. Corrections may be applied by replacing one or more of the sub-band images 262 from the spatial domain prediction data 124 with the corresponding sub-band image predictions from the frequency domain prediction data 122.

For example, the HH sub-band image of the sub-band images 262 derived from the spatial domain prediction data 124 may be replaced with the HH sub-band image prediction 242, and the LL sub-band image of the sub-band images 262 derived from the spatial domain prediction data 124 may be replaced with the LL sub-band image prediction 240. Because the frequency domain path 220 has specifically learned how to predict how characteristics of the HH and/or LL sub-band images should look without artifacts, using those derived sub-band predictions in place of the HH and/or LL sub-band images of the sub-band images 262 will introduce sharpness in high-frequency details without injecting artifacts. The resulting set of corrected LL, LH, HL, and HH sub-band images 262 may then be applied to an inverse DWT 264 to reconstruct a resampled resolution image prediction 140 (e.g., a wavelet-based reconstruction upsampled, downsampled, or fixed resolution reconstruction) of the original input image 202 that is adjusted to mitigate artifacts.

Referring now to FIG. 3, FIG. 3 provides non-limiting examples of a neural network basic block and residual block. As shown at 301, a basic block sequence (such as basic block sequences 226, 236, 252, and/or 256) may comprise a sequence or chain of basic blocks 310 where the output of one basic block 310 provides input for the next basic block 310. In this example, a basic block 310 may comprise a 3×3 2D convolution block 312 followed by an activation function block 314 (e.g., a ReLU activation function block and/or a sigmoid activation function block). As shown at 302, a residual block (such as residual block 254) may comprise a first 3×3 2D convolution block 322 followed by an activation function block 324 (e.g., a ReLU activation function block and/or a sigmoid activation function block), followed by a second 3×3 2D convolution block 326. A skip connection 325 may feed forward the input signal for summation with the resulting adjusted signal from the block sequence to produce an output from the residual block.

With respect to training, a wavelet frequency optimization model 120 may be iteratively trained (e.g., thousands of iterations) using training data samples, while blocks of the model are adjusted over the iterations to drive a feedback loss towards a minimum. Referring now to FIG. 4, an example training architecture 400 is described for training a wavelet frequency optimization model 120 in accordance with embodiments of this disclosure. Using the training architecture 400, the neural network blocks of the frequency domain path 220 and the spatial domain path 250 may be trained based on a loss function 450 designed to optimize various multiple loss components distributed across the paths. As shown in FIG. 4, the training architecture 400 comprises a loss function 450 to generate a feedback loss 448 used to iteratively update the wavelet frequency optimization model 120 during training as the training data 405 is processed by the wavelet frequency optimization model 120. The wavelet frequency optimization model 120 is iteratively trained and adjusted over the iterations to drive a feedback loss 448 towards a minimum.

During training, the wavelet frequency optimization model 120 may be iteratively trained (e.g., over many thousands of iterations) using training data 405 that comprises a set of training data samples 410. As shown in FIG. 4, each training data sample 410 may comprise a training image sample 412 and ground truth image sample 414, wherein the ground truth image sample 414 comprises a native resolution image that has not been previously downsampled, and the training image sample 412 comprises a resampled (e.g., downsampled) version of the ground truth image sample 414.

In some embodiments such as shown in FIG. 4, the training process for training the wavelet frequency optimization model 120 comprises an end-to-end training using the wavelet-based image reconstruction engine 110 in which the wavelet frequency optimization model 120 functions. For example, the training image sample 412 may be fed as an original input to the wavelet-based image reconstruction engine 110, which may perform an image resampling 430 (e.g., an upsampling) of the training image sample 412, and further process the upsampled training image sample into the one or more frequency sub-band images (e.g., using a DWT algorithm 432), such as described with respect to FIG. 2. The wavelet frequency optimization model 120 may process the frequency sub-band images from the DWT 432 as inputs to generate frequency domain prediction data, such as the HH sub-band prediction 442 and LL sub-band prediction 444. In some embodiments, the wavelet frequency optimization model 120 may generate such frequency domain prediction data for each of the LL, LH, HL, and/or HH sub-bands, or any combination thereof. The wavelet frequency optimization model 120 may process the upsampled training image as an input to generate spatial domain prediction data, such as the spatial domain prediction data 124 described with respect to FIG. 2. To produce the resampled resolution image prediction 446, the wavelet-based image reconstruction engine 110 processes (e.g., decomposes, transforms, deconstructs, etc.) the spatial domain prediction data from the wavelet frequency optimization model 120 into frequency sub-band images and applies corrections to the frequency sub-band images based on replacing one or more of the sub-band images with a corresponding sub-band prediction. Wavelet-based reconstruction may be performed by applying the set of corrected sub-band images to an inverse DWT to reconstruct the original training image sample 412 as the resampled resolution image prediction 446.

In order to compute the feedback loss, the training architecture 400 may compute ground truth values based on the ground truth image sample 414. For example, one or more ground truth decomposed frequency sub-band images may be derived (e.g., using a DWT algorithm 420) from the ground truth image sample 414 to produce frequency sub-band images 424 that include one or more LL, LH, HL, and/or HH sub-band ground truth images. The loss function 450 may compute a respective loss component associated with one or more of the sub-band image predictions produced by the wavelet frequency optimization model 120.

For example, the loss function 450 may input the HH sub-band image prediction 442 and the HH sub-band ground truth 428, and compute an HH prediction loss 452 (e.g., an L1 mean absolute error loss) between the two images. Similarly, the loss function 450 may input the LL sub-band image prediction 444 and the LL sub-band ground truth image 426, and compute an LL prediction loss 454 (e.g., an L1 mean absolute error loss) between those images. In some embodiments, an L1 loss may similarly be computed by the loss function for predictions based on HL and LH sub-band representations. Each of the sub-band image prediction losses associated with the decomposed sub-band image predictions defines components of the feedback loss 448 that may be used for iteratively adjusting the wavelet frequency optimization model 120 to drive those L1 losses toward zero.

With respect to end-to-end training of the wavelet-based image reconstruction engine 110, the feedback loss 448 further comprises at least one final image prediction loss 456 computed by the loss function 450 based on comparing the resampled resolution image prediction 446 with the training data sample ground truth image sample 414. Based on detecting deviations between the resampled resolution image prediction 446 and the training data sample ground truth image sample 414, the loss function 450 may compute, for example, an L1 loss and/or an L2 loss (e.g., a mean-squared error loss) that is fed back as a component of the feedback loss 448 and used for iteratively adjusting the wavelet frequency optimization model 120 to drive those L1 and/or L2 losses toward zero. In some embodiments, the loss components of feedback loss 448 for different sub-band image predictions may be weighted differently with respect to each other using scaling factors to emphasis training for one sub-band over another. For example, the HH sub-band loss 452 component may be scaled based on a first scaling factor while the LL sub-band loss 454 component may be scaled based on a second (smaller) scaling factor to focus learning on driving the HH sub-band loss to a minimum over driving the LL sub-band loss to a minimum. In some embodiments, frequency sub-band image predictions may be computed based on multi-level DWT operations—using an LL sub-band image prediction from a first iteration to compute a second set of frequency sub-band image predictions. In such embodiments, the wavelet frequency optimization model 120 may be trained using the training architecture 400 in the same manner described above to optimize losses associated with higher level frequency sub-band image predictions derived from the multi-level DWT operations.

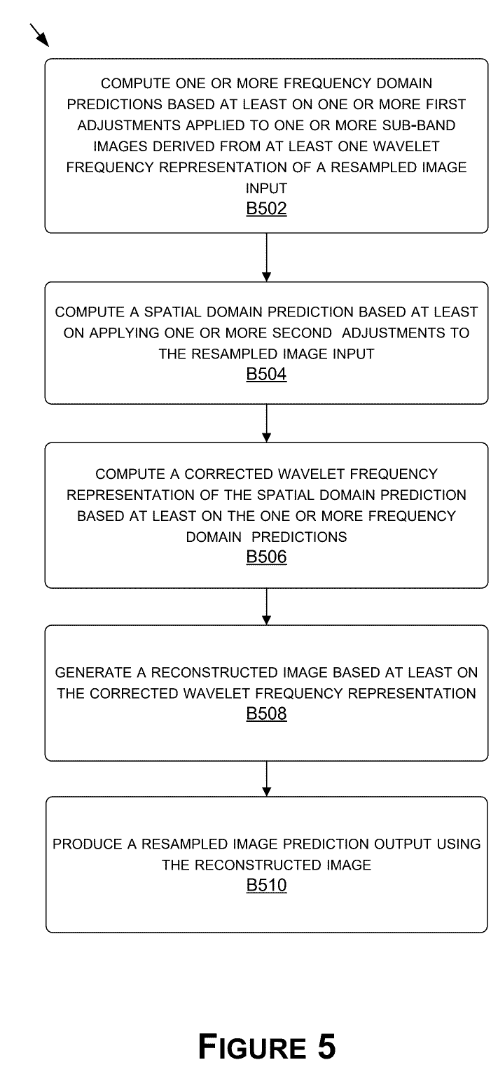

Now referring to FIG. 5, FIG. 5 is a flow diagram showing a method 500 for wavelet-based image reconstruction, in accordance with some embodiments of the present disclosure. The features and elements described herein with respect to the method 500 of FIG. 5 may be used in conjunction with, in combination with, or substituted for elements of any of the other embodiments discussed herein and vice versa. Further, the functions, structures, and other descriptions of elements for embodiments described in FIG. 5 may apply to like or similarly named or described elements across any of the figures and/or embodiments described herein and vice versa.

Each block of method 500, described herein, comprises a computing process that may be performed using any combination of hardware, firmware, and/or software. For instance, various functions may be carried out by one or more processors comprising processing circuitry and executing instructions stored in memory. The methods may additionally, or alternatively, be embodied as computer-usable instructions stored on computer storage media. The methods may be provided by a standalone application, a service or hosted service (standalone or in combination with another hosted service), or a plug-in to another product, to name a few. In addition, method 500 is described, by way of example, with respect to the wavelet-based image reconstruction engine 110 and/or wavelet frequency optimization model 120 described in FIGS. 1 and 2. However, these methods may additionally or alternatively be executed by any one system, or any combination of systems, including, but not limited to, those described herein.

In some embodiments, method 500 may generally be directed to generating image data representing resampled image data based at least on one or more non-linear adjustments applied to one or more sub-band images derived from at least one wavelet frequency representation of the resampled image data to produce a corrected set of one or more sub-band images, and generating a reconstructed image from the corrected set of one or more sub-band images based at least on an inverse wavelet frequency operation.

The method 500, at block B502, includes computing one or more frequency domain predictions based at least on one or more first (e.g., non-linear) adjustments applied to one or more sub-band images derived from at least one wavelet frequency representation of a resampled image input. In some embodiments, the resampled image input comprises an upsampled image or a downsampled image, based on an image data input. As explained with respect to FIG. 1, the resampling performed by the wavelet-based image reconstruction engine 110 may comprise an upsampling reconstruction (e.g., producing a higher resolution image of an image represented by the image data input 102), a downsampling reconstruction (e.g., producing a lower resolution image of an image represented by the image data input 102), or a fixed resolution reconstruction (e.g., producing an image having the same resolution as an image represented by the image data input 102, which may be performed for denoising purposes). The image data input 102 may comprise one or more image frames comprising still image content or video image content. In some embodiments, the image data input 102 may represent images that were cropped from larger images, cropped, downsampled, filtered, or otherwise processed from an original image using one or more lossy algorithms (e.g., algorithms and/or codecs that discard information from the original image data considered less important or undetectable to the human eye). The resulting image data input 102 may therefore comprise one or more artifacts - small distortions in an image or video cause by the lossy algorithms.

In some embodiments, the one or more frequency sub-band image predictions may be computed based at least on a discrete wavelet transform, and comprise at least one of: a low-low sub-band prediction, a high-high sub-band prediction, a low-high sub-band prediction, and a high-low sub-band prediction. In some embodiments, the one or more frequency sub-band image predictions comprise at least the low-low sub-band prediction and the high-high sub-band prediction. For example, the wavelet-based image reconstruction engine 110 may perform an image resampling 112, for example to upsample the input image to higher resolution image data. The resolution of the resampled original image data may define the target resolution for the resampled resolution image prediction 140 output generated by the wavelet image reconstruction engine 110. In some embodiments, image resampling 112 may comprise a bicubic resampling based on bicubic interpolation techniques. The wavelet-based image reconstruction engine may process the resampled original image data frequency sub-band decomposition, such as a DWT 114, to generate decomposed frequency sub-band images (e.g., LL, LH, HL, and HH sub-band images) of the upsampled original input image data.

The one or more frequency sub-band image predictions may be individually derived based on one or more non-linear corrections computed by one or more residual block-based frameworks of a frequency domain path of a machine learning model, such as illustrated with respect to FIG. 2. As shown in FIG. 2, the wavelet frequency optimization model 120 may comprise a neural network architecture that includes a frequency domain path 220 and a spatial domain path 250. Each path may comprise trainable sequences of two-dimensional (2D) convolution blocks, residual blocks, activation function blocks, or other functional blocks (where a block defines a set of one or more neural network layers that propagate a defined function). The frequency domain path 220 may input and process the one or more decomposed frequency sub-band images 204 (e.g., LL, LH, HL, and HH sub-band images) produced by the DWT 114 based on the upsampled original input image. The sub-band predictions may define the set of frequency domain prediction data 122. In various embodiments, the frequency domain path 220 may input and process each of the frequency sub-band images 204, or a selected combination of the frequency sub-band images 204. In some embodiments, the method may compute the at least one wavelet frequency representation of the resampled image input based at least on a multi-level decomposition of the resampled image input.

The method 500, at block B504, includes computing a spatial domain prediction based on applying one or more second (e.g., non-linear) adjustments to the resampled image input. The spatial domain prediction may be derived based at least on one or more non-linear corrections computed using a residual block-based framework of a spatial domain path of a neural network model. As discussed with respect to FIG. 2, the spatial domain path 250 may input and process the resampled original input image produced by image resampling 112 to introduce non-linear corrections in the spatial domain of the resampled image to produce the spatial domain prediction data 124. The spatial domain path 250 may comprise a residual block framework 251 that is trained to generate the spatial domain prediction data 124 based on the resampled original input image. In some embodiments, the one or more first non-linear adjustments and the one or more second non-linear adjustments may be based at least on two-dimensional convolution operations.

The method 500, at block B506, includes computing a corrected wavelet frequency representation of the spatial domain prediction based at least on the one or more frequency domain predictions. Substantive corrections to address artifacts in the spatial domain prediction data 124 may be applied by mapping the spatial domain prediction data 124 into frequency sub-band images 262 (e.g., LL, LH, HL, and HH sub-band images produced by a DWT algorithm 260) and the correcting one or more of those sub-band images based on the sub-band predictions from frequency domain prediction data 122.

The method 500, at block B508, includes generating a reconstructed image based at least on the corrected wavelet frequency representation. The method 500, at block B510, includes producing a resampled image prediction output using the reconstructed image. In some embodiments the one or more frequency sub-band image predictions may be computed based at least on a wavelet frequency decomposition algorithm comprising a discrete wavelet transform (DWT), and the wavelet-based image reconstruction generated based at least on applying inverse DWT operations to the corrected wavelet frequency representation. For example, the wavelet image reconstruction engine 110 may perform a wavelet-based reconstruction 130 based on predictions from the wavelet frequency optimization model 120 to produce a resampled (e.g., upsampled) resolution image prediction output from the wavelet image reconstruction engine 110. Corrections may be applied by replacing one or more of the sub-band images 262 from the spatial domain prediction data 124 with the corresponding sub-band image predictions from the frequency domain prediction data 122. The resulting set of corrected LL, LH, HL, and HH sub-band images 262 may then be applied to an inverse DWT 264 to reconstruct a resampled resolution image prediction 140 (e.g., a wavelet-based reconstruction upsampled, downsampled, or fixed resolution reconstruction) of the original input image 202 that is adjusted to mitigate artifacts.

In some embodiments, the one or more frequency sub-band image predictions and the spatial domain prediction may be generated based on a machine learning model trained based at least on a loss function comprising a loss component for a frequency sub-band prediction loss, and a loss component for a resampled image prediction loss. To generate a feedback loss, a loss function may compute a respective loss component associated with each sub-band image prediction based on its corresponding sub-band ground truth image. For example, the loss function may input the HH sub-band image prediction produced by the model and the HH sub-band ground truth image, and compute an L1 loss (e.g., a mean absolute error loss) between the images. Similarly, the loss function may input the LL sub-band image prediction produced by the model and the LL sub-band ground truth image, and compute an L1 loss between those images. In some embodiments, an L1 loss may similarly be computed by the loss function for the HL and LH sub-band decompositions. Each of the L1 losses associated with the sub-band image prediction defines components of the feedback loss used for iteratively adjusting the wavelet frequency optimization model to drive those L1 losses toward zero. With respect to end-to-end training, the feedback loss further comprises at least one loss computed by the loss function based on comparing the upsampled resolution image prediction output from the wavelet-based image reconstruction engine to the training data sample ground truth image. Based on detecting deviations between the upsampled resolution image prediction and the training data sample ground truth image, the loss function may compute an L1 loss and/or an L2 loss (e.g., a mean-squared error loss) that is fed back as a component of the feedback loss and used for iteratively adjusting the wavelet frequency optimization model to drive those L1 and/or L2 losses toward zero.

In some embodiments, the systems and methods described herein may be performed within, or in conjunction with, a simulation environment (e.g., NVIDIA's DriveSIM) using simulated data (e.g., simulated sensor data of simulated sensors of a virtual or simulated machine). For example, input image data 102 may be generated from within the simulation environment, and the simulation may use resampled resolution image predictions 140 to perform operations (e.g., navigating, vehicle safety features, etc.) associated with the virtual machine within the environment. These simulated operations may be used to test performance of the underlying algorithms, systems, and/or processes prior to deploying them in the real world. In some instances, the simulation may be used to generate resampled resolution image predictions 140 for use as synthetic training data—e.g., training data including regions of interest and/or subregions of interest from within the simulation. The synthetic training data (in addition to or alternatively from real-world data) may then be processed for various operations. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the image processing system 100 may comprise a component of a system, such as a content collaboration platform, for using or developing universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models - such as one or more large language models (LLMs) and/or one or more vision language models (VLMs), systems for performing light transport simulation, systems for performing collaborative content creation for 3D assets, systems implemented at least partially using cloud computing resources, and/or other types of systems.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof. In some embodiments, one or more functions of the wavelet based image reconstruction engine 110, wavelet frequency optimization model 120, and/or training architecture 400 described herein may be implemented at least in part using code executed on one or more of the CPUs 606, GPUs 608 and/or Logic Unit(s) 620.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740. In some embodiments, one or more functions of the wavelet based image reconstruction engine 110, wavelet frequency optimization model 120, and/or training architecture 400 described herein may be implemented at least in part using data center 700.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R. s from among node C.R. s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM). In some embodiments, one or more functions of the wavelet based image reconstruction engine 110, wavelet frequency optimization model 120, and/or training architecture 400 described herein may be executed on one or more of the C.R.s 716(1)-716(N).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In some embodiments, one or more functions of the wavelet based image reconstruction engine 110, wavelet frequency optimization model 120, and/or training architecture 400 described herein may be implemented at least in part using application(s) 742 and/or software 732.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
compute one or more frequency domain predictions based at least on one or more first adjustments applied to one or more sub-band images derived from at least one wavelet frequency representation of a resampled image input;
compute a spatial domain prediction based at least on applying one or more second adjustments to the resampled image input;
compute a corrected wavelet frequency representation of the spatial domain prediction based at least on the one or more frequency domain predictions; and
generate a reconstructed image based at least on the corrected wavelet frequency representation; and
produce a resampled image prediction output using the reconstructed image.

2. The one or more processors of claim 1, wherein the one or more processors are further to compute the at least one wavelet frequency representation of the resampled image input based at least on a multi-level decomposition of the resampled image input.

3. The one or more processors of claim 1, wherein the resampled image input comprises an upsampled image or a downsampled image, based at least on an image data input.

4. The one or more processors of claim 1, wherein the one or more processors are further to compute the one or more frequency domain predictions based at least on a discrete wavelet transform, wherein the one or more frequency domain predictions comprise at least one of:
a low-low sub-band prediction, a high-high sub-band prediction, a low-high sub-band prediction, and a high-low sub-band prediction.

5. The one or more processors of claim 4, wherein the one or more frequency domain predictions include at least the low-low sub-band prediction and the high-high sub-band prediction.

6. The one or more processors of claim 1, wherein the one or more frequency domain predictions are individually derived based at least on one or more non-linear corrections computed by one or more residual block-based frameworks of a frequency domain path of a machine learning model.

7. The one or more processors of claim 1, wherein the spatial domain prediction is derived based at least on one or more non-linear corrections computed using a residual block-based framework of a spatial domain path of a neural network model.

8. The one or more processors of claim 1, wherein the one or more first adjustments and the one or more second adjustments are based at least on two-dimensional convolution operations.

9. The one or more processors of claim 1, wherein the one or more processors compute the one or more frequency domain predictions based at least on a wavelet frequency decomposition algorithm comprising a discrete wavelet transform (DWT); and
generate the reconstructed image based at least on applying the corrected wavelet frequency representation to an inverse DWT.

10. The one or more processors of claim 1, wherein the one or more frequency domain predictions and the spatial domain prediction are generated based at least on a machine learning model trained based at least on a loss function comprising at least a first loss component for a frequency sub-band prediction loss, and at least a second loss component for a resampled image prediction loss.

11. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

12. A system comprising one or more processors to:
compute a corrected wavelet frequency representation for a resampled image input based at least on one or more frequency domain predictions individually computed based at least on one or more first adjustments applied to one or more sub-band images derived from at least one initial wavelet frequency representation of the resampled image input; and
generate a reconstructed image based at least on the corrected wavelet frequency representation to produce a resampled image prediction output.

13. The system of claim 12, the one or more processors further to:
compute a spatial domain prediction based at least on applying one or more second adjustments to the resampled image input; and
wherein the corrected wavelet frequency representation is based at least on a correction of the spatial domain prediction based at least on the one or more frequency domain predictions.

14. The system of claim 13, wherein the spatial domain prediction is derived based at least on one or more non-linear corrections computed using a residual block-based framework of a spatial domain path of a neural network model.

15. The system of claim 12, wherein the one or more processors are further to compute the at least one wavelet frequency representation of the resampled image input based at least on a multi-level decomposition of the resampled image input.

16. The system of claim 12, wherein the one or more processors are further to execute a machine learning model, wherein the one or more frequency domain predictions are individually derived based at least on one or more non-linear corrections computed by one or more residual block-based frameworks of a frequency domain path of the machine learning model.

17. The system of claim 12, wherein the one or more processors are further to compute the one or more frequency domain predictions based at least on a wavelet frequency decomposition algorithm comprising a discrete wavelet transform (DWT); and
generate the reconstructed image based at least on applying the corrected wavelet frequency representation to an inverse DWT.

18. The system of claim 12, wherein the one or more processors are further to compute the one or more frequency domain predictions based at least on a discrete wavelet transform, wherein the one or more frequency domain predictions comprise a combination of one or more of:
a low-low sub-band prediction, a high-high sub-band prediction, a low-high sub-band prediction, and a high-low sub-band prediction.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

20. A method comprising:
generating image data representing resampled image data based at least on one or more non-linear adjustments applied to one or more sub-band images derived from at least one wavelet frequency representation of the resampled image data to produce a corrected set of one or more sub-band images, and generating a reconstructed image from the corrected set of one or more sub-band images based at least on an inverse wavelet frequency operation.
